(19) United States
(12) Patent Application Publication
(10) Pub. No.: US 2018/0370416 A1
(43) Pub. Date: Dec. 27, 2018

(54) Rackless Harness System

(71) Applicant: John Nissen, Henderson, CO (US)

(72) Inventor: John Nissen, Henderson, CO (US)

(21) Appl. No.: 15/631,132

(22) Filed: Jun. 23, 2017

(51) Int. Cl. B60P 7/06; B60R 11/00; B60P 7/00; B60R 7/02

(52) U.S. Cl. CPC B60P 7/06; B60R 11/00; B60R 2011/0064; B60R 7/02; B60R 2011/0059; B60P 7/00

(57) ABSTRACT

A harness system is provided that, in some embodiments, provides for at least one wrap element that may be configured to removably retain at least one cargo element, and wherein the at least one wrap element is configured to removably attach to at least one tie-down on a truck. In some embodiments, the at least one wrap element may also provide for a non-scratch outer layer and one or more zippered pouches, as well as a detachable flag and detachable LED light strip element.

### CROSS-REFERENCE TO RELATED APPLICATION

Not applicable.

### TECHNICAL FIELD

The present invention relates generally to the field of truck accessories and more specifically relates to a harness system for use with a truck.

### BACKGROUND

Many persons wish to be able to transport cumbersome objects using a truck, but do not wish to install a permanent rack on the truck. In such a circumstance, the person may put down blankets on the truck bed, use straps and pads, or otherwise attempt to secure the potentially heavy, large, or oddly shaped load in such a way as to prevent damage to the truck bed, but while also not damaging the cargo. Particularly with respect to construction-related transportation needs, such attempts can be ill-fated. Having no better option, many persons end up installing racks on their pickup, such as a “headache rack” or a “ladder rack.” This result is unfortunate because not only does it permanently change the truck's integrity, it changes the aesthetic properties and even the vibratory qualities of the truck's performance. What is needed is a truck rack system that can be installed and uninstalled easily, that prevents damage to the truck, and that can accommodate various loads.

Various attempts to solve this problem have been made. One such attempt can be seen with respect to U.S. Pat. No. 8,240,963, incorporated by reference in its entirety herein, which generally discloses a built-in carrying system for a truck bed. While this disclosure does provide for an adaptable truck bed rack system, its built-in nature prevents its removal.

Another attempt can be seen with respect to U.S. Pat. No. 5,551,379, incorporated by reference in its entirety herein, which generally discloses a strap and hook system having many different settings and that is configured to secure into existing truck bed hooks. While this disclosure does provide for a versatile and easily removed cargo securing system, its relatively fluid design and lack of support structures prevents it from being used for large or heavy loads.

Yet another attempt can be seen with respect to U.S. Pat. No. 4,964,771, incorporated by reference in its entirety herein, which generally discloses a strap-and blanket type cargo restraining system. While this disclosure does provide for a secure and versatile cargo restraint system, and one that can accommodate larger loads, its lack of support structure prevents it from prohibiting damage to the cargo bed by heavy objects.

Various attempts have been made to solve the problems which may be found in the related art but have thus far been unsuccessful. A need exists for a new harness system adapted for use with a truck to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a harness system that overcomes the deficiencies of the prior art. It is contemplated that the present invention may provide a harness system that enables a truck driver to transport large, heavy loads without damaging his or her truck.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel harness system. The general purpose of the present invention, which will be described subsequently in greater detail, is to provide a harness system having a ladder and at least one cargo wrap element. The features of the invention which are believed to be novel are particularly pointed out and distinctly claimed in the concluding portion of the specification. These and other features, aspects, and advantages of the present invention will become better understood with reference to the following drawings and detailed description.

In some embodiments, the present invention may provide for two wrap elements that may be configured to removably attach to one or more truck bed tie-down locations, one near the tailgate and one near the cab. In one embodiment, the present invention may provide for a ladder-shaped center element that, in some embodiments, is long enough to stretch beyond a truck's tailgate on the one end and the truck's rear window on the other.

The present invention's wrap elements, may be configured to wrap around a cargo item and secure the cargo against either the truck, the center element, or both the truck and the center element. The wrap element(s) may provide for one or more handle elements, one or more pouch elements (which may include a zipper enclosure), and one or more non-scratch resistance padding elements. The center element (if provided) may provide for one or more flag elements attached to the tailgate-side of the center element, wherein the flag element is configured to hang down and alert drivers as to the presence of the load. In some embodiments, the flag may be detachable and/or configured for use with either end of the center element. The wrap elements may also provide for one or more LED or other lighting elements. In some embodiments, the wrap elements may have one or more straps and one or more buckles, or other similar securement systems, wherein a user may feed the strap through the buckle and tighten the connection between the strap and the buckle and in some embodiments, to trap the load in place against the center element (if provided) or against the truck bed, by tightening the wrap element to itself. In other embodiments, a zip-tie or ratcheting tie-down connection element may be used to secure one end of the wrap to the other end of the wrap, or the wrap to the center element (if provided). In some embodiments, the present invention may provide for two harnesses, an upper harness and a lower harness, wherein the harnesses are configured differently.

In some embodiments, the present invention's dual harness design may enable users to transport ladders, lumber, pipes, and other items without needing a construction rack attached to the user's truck. The present invention may also enable users to safely secure loads of material for transport to be fastened to the truck in various ways, and enable users to unload construction material by being able to carry loads, while still fastened by the product, off the truck and manually transported into a job site or any destination. The present invention's upper harness, in some embodiments, can be used by itself once off the truck. In such a scenario, a user could lay the upper harness in the middle of the load, then attach a shoulder strap element to the present invention's harness element, thus enabling one person to transport the load to a destination in a safe way.

To use the present invention, a user may first secure the upper harness and lower harness to the load of material ready to transport, and then to the center element. The load may then be fastened by attaching a strap or bungee cord element to the handle loop elements that may be located on both sides of one or both harnesses and then fasten one or both harnesses to the inside of the bed of the truck to the standard location that all trucks manufacturers provide in the inside of the bed of the truck. The present invention may also be used to transport loads by foot, with individuals using the product as a carrying device to carry from truck to destination. Both harnesses can be used in many different ways on how the user may want to transport a load, such as by truck or by foot.

In some embodiments, the present invention may provide for a dual harness system suitable for transporting construction loads using a pickup truck. One or more padding elements on either harness may prevent damage to the truck and the cargo. Either harness may also provide for a zipper pouch on one or more sides of the wrap, wherein the zipper pouch may store the strap downs (the strap downs being the fixed elements to the wrap enabling the wrap to tighten to itself, the truck, or a center element). In some embodiments, one or more wraps may comprise a nylon or canvas material having the aforementioned strap downs. One or more harnesses may also provide for another zipper pouch, or a pouch that utilizes one or more hook and loop enclosures, wherein the pouch is configured to store a flag or LED lights that may be used to notify other drivers in the day or night, respectively. One or more harnesses may provide for adjustable buckle enclosures configured to work with the strap downs. The wrap elements are contemplated to be easily removable and non-marking. In some embodiments, one or more wraps may be two and a half feet by three and a half feet. In some embodiments, the present invention's wraps may be made in whole or in part from sheepskin.

The unique features of the present invention may provide the following benefits for one or more consumers: it may enable a user to not need a ladder rack on a truck for small loads, such as a ladder or smaller bundles of lumber, pvc pipes, etc. It also may provide a way of taking the secure load off a truck with just one or two persons, while load stays secure in a safe manner ready for transport by foot. It also may enable a user to transport loads without installing a permanent rack or damaging one's truck. When not in use, the present invention can be stored out of sight.

### BRIEF DESCRIPTION OF THE DRAWINGS

These and other features, aspects and advantages of the present invention will become better understood with regard to the following description, appended claims, and accompanying figures where:

FIG. 1 shows a front perspective view of a harness system in accordance with one embodiment of the invention.

FIG. 2 shows a rear perspective view of a harness system in accordance with one embodiment of the invention.

FIG. 3 shows a front perspective view of a harness system in accordance with one embodiment of the invention.

FIG. 4 shows a rear perspective view of a harness system in accordance with one embodiment of the invention.

FIG. 5 shows a front perspective view of a harness system in accordance with one embodiment of the invention.

FIG. 6 shows a top perspective view of a harness system in accordance with one embodiment of the invention.

FIG. 7 shows a side perspective view of a harness system in accordance with one embodiment of the invention.

FIG. 8 shows a rear perspective view of a harness system in accordance with one embodiment of the invention.

### DETAILED DESCRIPTION

The present invention overcomes the limitations of the prior art by providing a new and more effective harness system.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

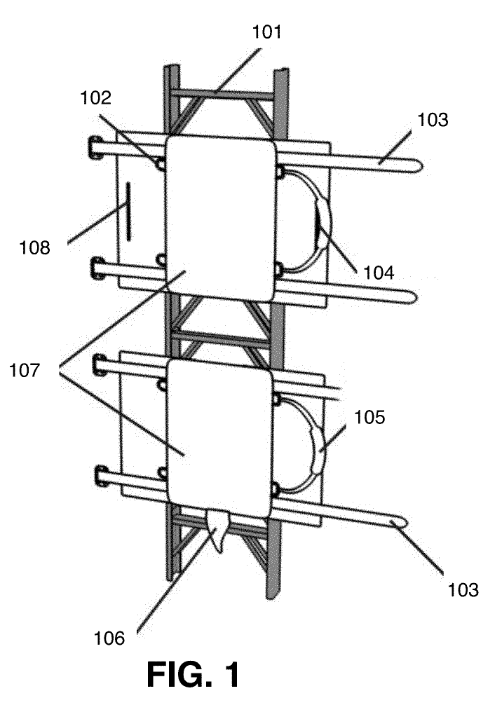

Turning attention to FIG. 1, a front perspective view of a harness system in accordance with one embodiment of the invention is shown. In the embodiment depicted, a viewer may perceive ladder 101, nylon handles 102, straps 103 (that wrap around load), zipper 104, optional carrying strap 105, flag 106, non-scratch resistance padding 107, and zipper that opens to pouch storing strap-downs 108.

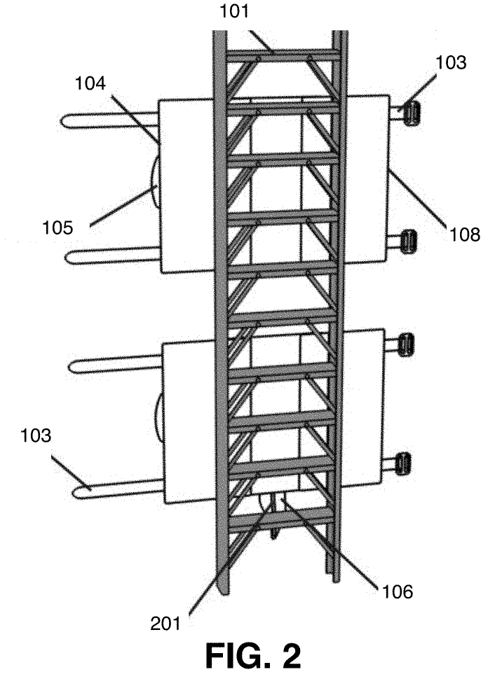

With respect to FIG. 2, a rear perspective view of a harness system in accordance with one embodiment of the invention is shown. In the embodiment depicted, a viewer may perceive LED strip 201, as well as straps 103, zipper 104, optional carrying strap 105, flag 106, and zipper that opens to pouch storing strap-downs 108.

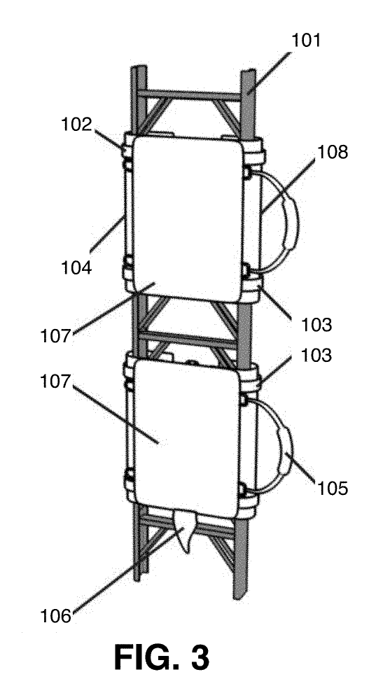

With respect to FIG. 3, a front perspective view of a harness system in accordance with one embodiment of the invention is shown. In the embodiment depicted, a viewer may perceive ladder 101, nylon handles 102, straps 103 (that wrap around load), zipper 104, optional carrying strap 105, flag 106, non-scratch resistance padding 107, and zipper that opens to pouch storing strap-downs 108.

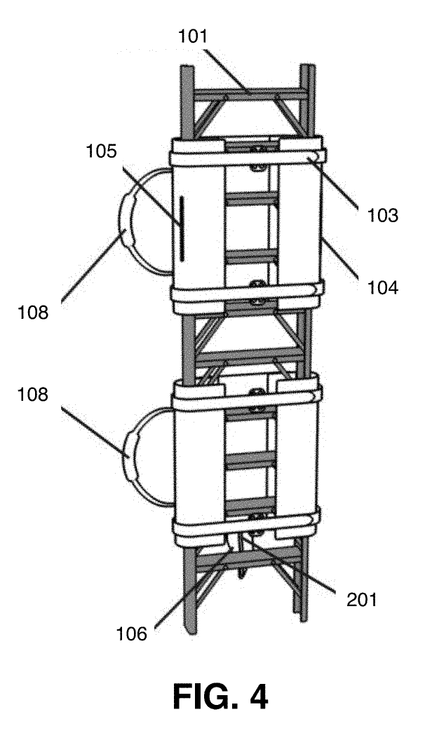

With respect to FIG. 4, a rear perspective view of a harness system in accordance with one embodiment of the invention is shown. In the embodiment depicted, a viewer may perceive LED strip 201, as well as straps 103, zipper 104, optional carrying strap 105, flag 106, and zipper that opens to pouch storing strap-downs 108.

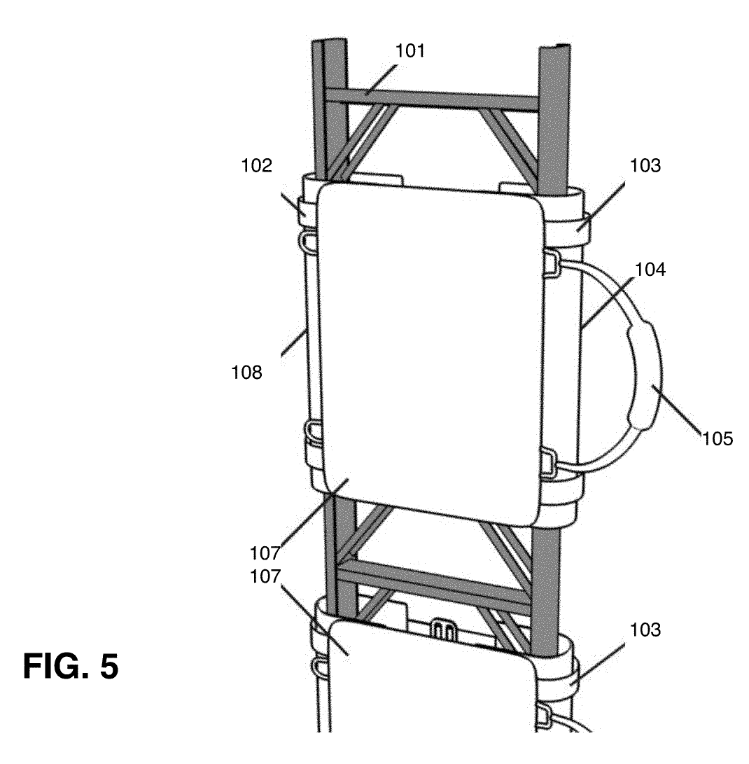

With respect to FIG. 5, a front perspective view of a harness system in accordance with one embodiment of the invention is shown. In the embodiment depicted, a viewer may perceive ladder 101, nylon handles 102, straps 103 (that wrap around load), zipper 104, optional carrying strap 105, non-scratch resistance padding 107, and zipper that opens to pouch storing strap-downs 108.

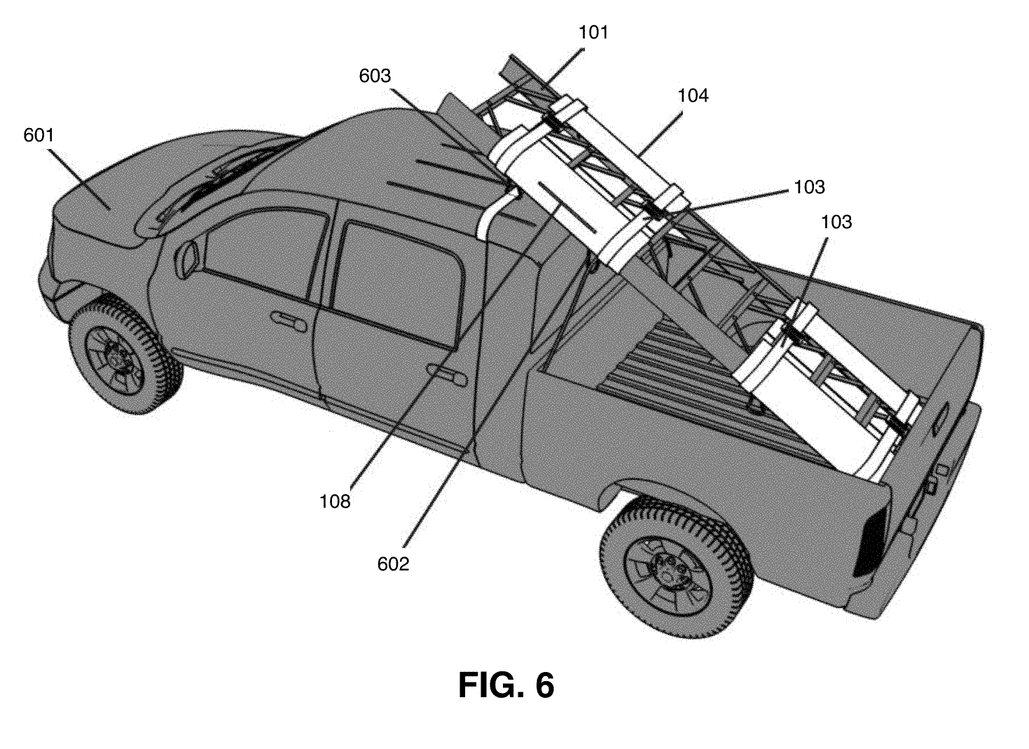

With respect to FIG. 6, a top perspective view of a harness system in accordance with one embodiment of the invention is shown. In the embodiment depicted, a viewer may perceive truck 601, nylon straps 602, strap downs 603, as well as ladder 101, straps 103 (that wrap around load), zipper 104, and zipper that opens to pouch storing strap-downs 108.

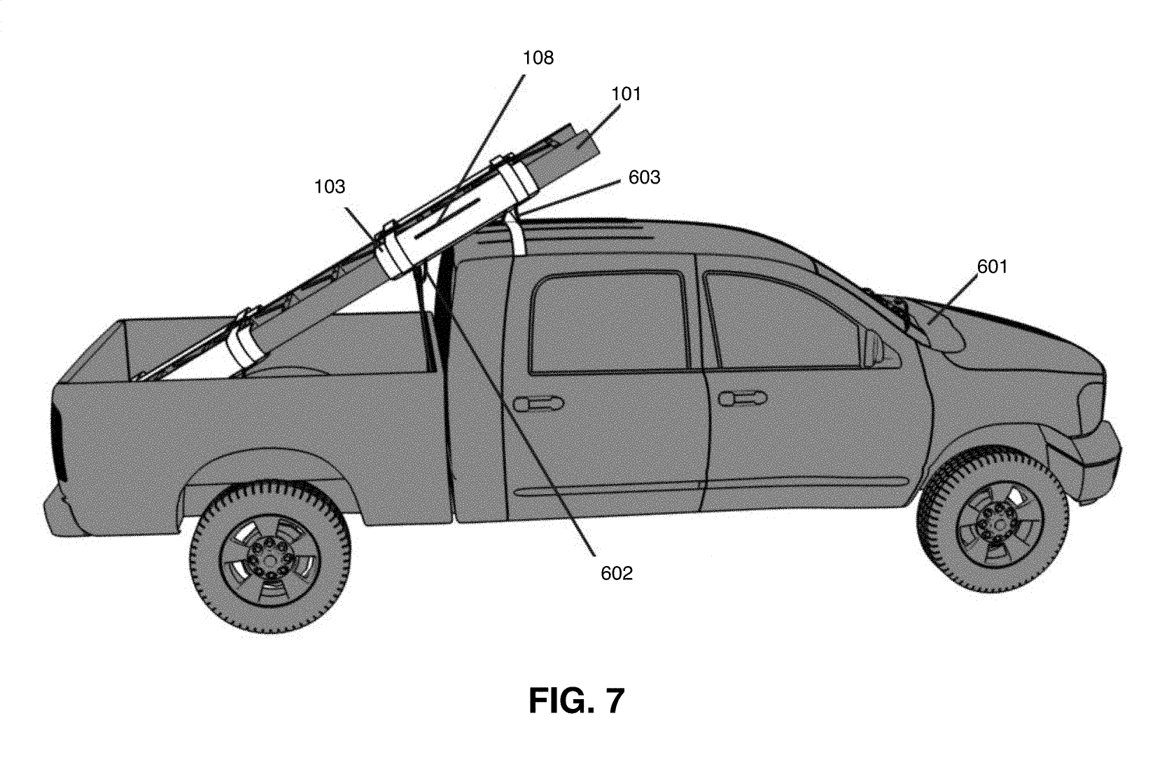

With respect to FIG. 7, a side perspective view of a harness system in accordance with one embodiment of the invention is shown. In the embodiment depicted, a viewer may perceive truck 601, nylon straps 602, strap downs 603, as well as ladder 101, straps 103 (that wrap around load), and zipper that opens to pouch storing strap-downs 108.

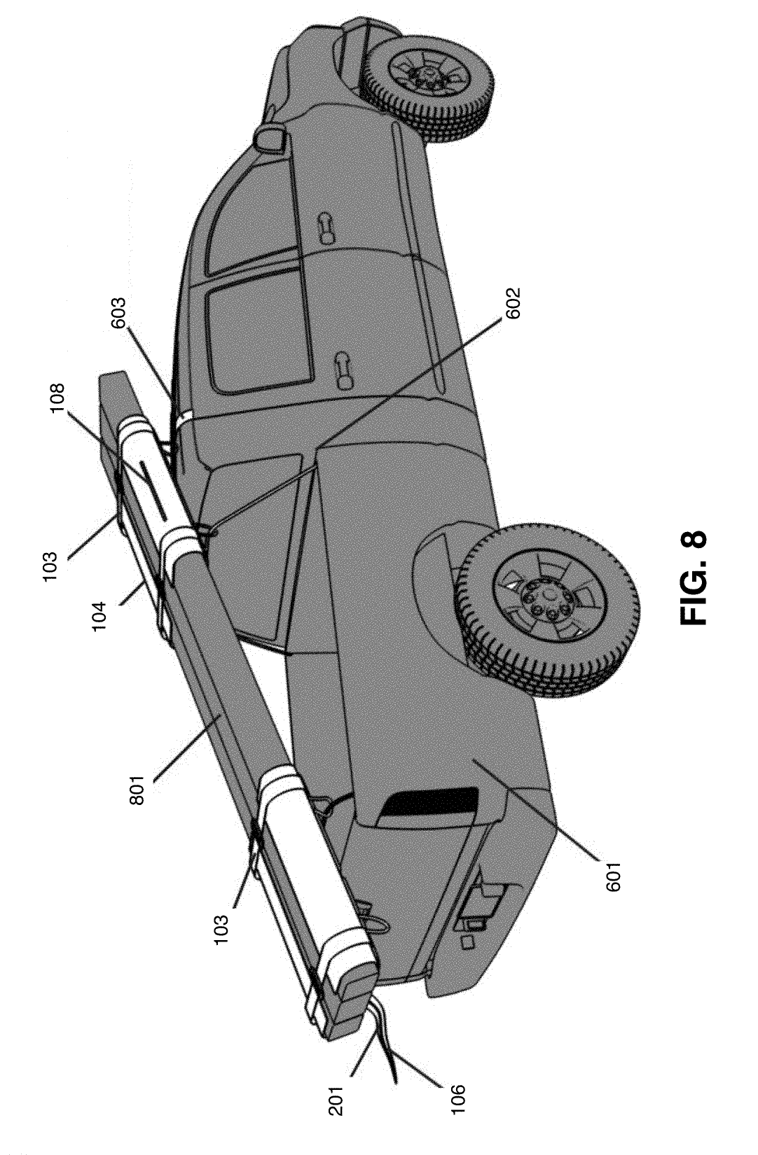

With respect to FIG. 8, a rear perspective view of a harness system in accordance with one embodiment of the invention is shown. In the embodiment depicted, a viewer may perceive lumber 801, as well as LED strip 201, truck 601, nylon straps 602, strap downs 603, straps 103, zipper 104, flag 106, and zipper that opens to pouch storing strap-downs 108.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the harness system generally described herein has been disclosed in connection with a number of embodiments shown and described in detail, various modifications should be readily apparent to those of skill in the art.

What is claimed is:

1. A harness system comprising:
at least one wrap element having at least one strap element, the strap element having a strap and a buckle, wherein the wrap element is configured to removably secure to a tie-down, wherein the tie-down is fixedly connected to a vehicle, and wherein the at least one wrap element is configured to removably secure at least one cargo item.

2. The system of claim 1, further comprising at least one handle fixedly connected to the at least one wrap element.

3. The system of claim 1, further comprising at least one pouch fixedly connected to the at least one wrap element, wherein the pouch is opened or closed via a zipper.

4. The system of claim 1, further comprising a non-scratch resistance padding affixed to at least one side of the at least one wrap element.

5. The system of claim 1, further comprising a flag removably attached to the at least one wrap element.

6. The system of claim 1, further comprising an LED light strip removably attached to the at least one wrap element.

7. The system of claim 1, wherein the vehicle is a truck.

8. The system of claim 1, further comprising one or more nylon straps fixedly connected to the at least one wrap element.

9. The system of claim 1, further comprising one or more strap down elements fixedly connected to the at least one wrap element.
